(19) United States
(12) Patent Application Publication
(10) Pub. No.: US 2025/0218634 A1
(43) Pub. Date: Jul. 3, 2025

(54) ELECTRONIC DEVICE, MAGNETIC CONNECTION MECHANISM, AND MAGNETIC ASSEMBLY THEREOF

(71) Applicant: INDUSTRIAL TECHNOLOGY RESEARCH INSTITUTE, Hsinchu (TW)

(72) Inventors: Cheng-Chung CHIU, Zhubei City (TW); Yu-Ting HUANG, Hsinchu City (TW); Shi-Yuan TONG, Zhudong Township (TW); Mean-Jue TUNG, Baoshan Township (TW)

(73) Assignee: INDUSTRIAL TECHNOLOGY RESEARCH INSTITUTE, Hsinchu (TW)

(21) Appl. No.: 18/399,215

(22) Filed: Dec. 28, 2023

(51) Int. Cl. H01F 7/02; G06F 1/16; H01F 1/057; H01F 7/04

(52) U.S. Cl. CPC H01F 7/021; G06F 1/1679; H01F 1/057; H01F 7/0221; H01F 7/04

(57) ABSTRACT

A magnetic assembly is provided, including an annular main magnetic element and an annular axillary magnetic element. The main magnetic element has a plurality of main magnetic segments of different polar directions and lengths. The axillary magnetic element has a plurality of axillary magnetic segments of different polar directions and lengths, corresponding to the main magnetic segments.

### TECHNICAL FIELD

The disclosure relates to a magnetic assembly, and, in particular, to a magnetic assembly with adjustable holding force and shear force.

### BACKGROUND

In many consumer electronics or industrial products, it is often needed to use magnets for temporarily attaching different parts of the product (e.g. the housing and the cover) to each other. As demagnetization of traditional single-pole magnets could be difficult, it is usually needed to control the magnetic force by adding external coils to generate additional magnetic fields. However, this may increase the complexity of the mechanism.

In view of this, to design a magnet assembly that can be widely used in various electronic products for adjusting the magnetic force has become a challenge for the persons skilled in this technical field.

### SUMMARY

The present disclosure provides a magnetic assembly that includes an annular main magnetic element and an annular auxillary magnetic element. The annular main magnetic element has a plurality of main magnetic segments, wherein the polar directions of the main magnetic segments are not exactly the same, and the angles of the main magnetic segments are not exactly the same. The annular axillary magnetic element is movably disposed on a side of the main magnetic element and has a plurality of axillary magnetic segments corresponding to the main magnetic segments, wherein the polar directions of the axillary magnetic segments are not exactly the same, and the angles of the axillary magnetic segments are not exactly the same.

The present disclosure provides an electronic device that includes the aforementioned magnetic assembly, a first module, and a second module. The main magnetic element is disposed on the first module, and the axillary magnetic element is disposed on the second module. When the axillary magnetic element is located at a first angular position relative to the main magnetic element, the main magnetic element and the axillary magnetic element generate a first magnetic force, whereby the second module is magnetically adhered to the first module. When the axillary magnetic element rotates from the first angular position relative to the main magnetic element to a second angular position, the main magnetic element and the axillary magnetic element generate a second magnetic force that is less than the first magnetic force.

The present disclosure provides a magnetic connection mechanism the includes the aforementioned magnetic assembly, a first member, and a second member. The main magnetic element is disposed on the first member, and the axillary magnetic element is disposed on the second member. When the axillary magnetic element is located at a first angular position relative to the main magnetic element, the main magnetic element and the axillary magnetic element generate a first magnetic force, whereby the second member is magnetically adhered to the first member. When the axillary magnetic element rotates from the first angular position relative to the main magnetic element to a second angular position, the main magnetic element and the axillary magnetic element generate a second magnetic force that is less than the first magnetic force.

A detailed description is given in the following embodiments.

### BRIEF DESCRIPTION OF THE DRAWINGS

The present invention can be more fully understood by reading the subsequent detailed description and examples with references made to the accompanying drawings, wherein:

FIG. 1 shows a perspective view of an electronic device 100 in the open state according to an embodiment of the present disclosure.

FIG. 2 shows a perspective view of the second module 20 when rotating relative to the first module 10 in FIG. 1, whereby the electronic device 100 is switched from the open state to the closed state.

FIG. 3 shows a perspective view of the main magnet element M and the auxiliary magnet element m when they are distant from each other.

FIG. 4 shows a perspective view of the main magnet element M and the auxiliary magnet element m when close to each other.

FIG. 5 is a schematic diagram showing the relationship between the angle of the auxiliary magnet element m relative to the main magnet element M and the magnetic attractive holding force/shear force between the main and auxiliary magnet elements M and m.

FIG. 6 is a schematic diagram showing the auxiliary magnet element m when rotating 90 degrees relative to the main magnet element M from the state of FIG. 4.

FIG. 7 is a schematic diagram showing the auxiliary magnet element m when rotating 180 degrees relative to the main magnet element M from the state of FIG. 4.

FIG. 8 is a schematic diagram showing the auxiliary magnet element m when rotating 270 degrees relative to the main magnet element M from the state of FIG. 4.

FIG. 9 is a schematic diagram showing a magnet assembly 50 according to another embodiment of the present disclosure.

FIG. 10 is a schematic diagram showing the relationship between the angle of the auxiliary magnet element m relative to the main magnet element M in FIG. 9 and the magnetic attractive holding force/shear force between the main and auxiliary magnet elements M and m.

FIG. 11 is a schematic diagram showing a magnet assembly 60 according to another embodiment of the present disclosure.

FIG. 12 is an exploded view of the first member 71, the second member 72, and the mobile phone 73 before assembly, in accordance with another embodiment of the present disclosure.

FIG. 13 is an exploded view of the first member 71 and the second member 72 in FIG. 12 from another viewing angle.

FIG. 14 is a cross-segmental view of the first member 71 and the second member 72 in FIG. 13 after assembly.

FIG. 15 is a schematic diagram showing a magnetic connection mechanism 80 (headphone box) in accordance with another embodiment of the present disclosure.

FIG. 16 is a side view of the second member 82 in FIG. 15 when closed relative to the first member 81.

FIG. 17 is a side view of the second member 82 in FIG. 15 when opened relative to the first member 81.

FIG. 18 is a side view showing the second member 92 of the magnetic connection mechanism 90 (headphone box) when closed relative to the first member 91, in accordance with another embodiment of the present disclosure.

FIG. 19 is a side view showing the second member 92 in FIG. 18 when opened relative to the first member 91.

### DETAILED DESCRIPTION

The electronic device, magnetic connection mechanism, and magnetic assembly thereof are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Moreover, the use of ordinal terms such as “first”, “second”, “third”, etc., in the disclosure to modify an element does not by itself connote any priority, precedence, or der of one claim element over another or the temporal order in which it is formed, but are used merely as labels to distinguish one claim element having a certain name from another element having the same name (but for use of the ordinal term) to distinguish the claim elements.

It should be noted that the elements or devices in the drawings of the disclosure may be present in any form or configuration known to those skilled in the art. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The drawings described are only schematic and are non-limiting. In the drawings, the size, shape, or thickness of some of the elements may be exaggerated and not drawn on scale for illustrative purposes. The dimensions and the relative dimensions do not correspond to actual location to practice of the disclosure. The disclosure will be described with respect to particular embodiments and with reference to certain drawings but the disclosure is not limited thereto.

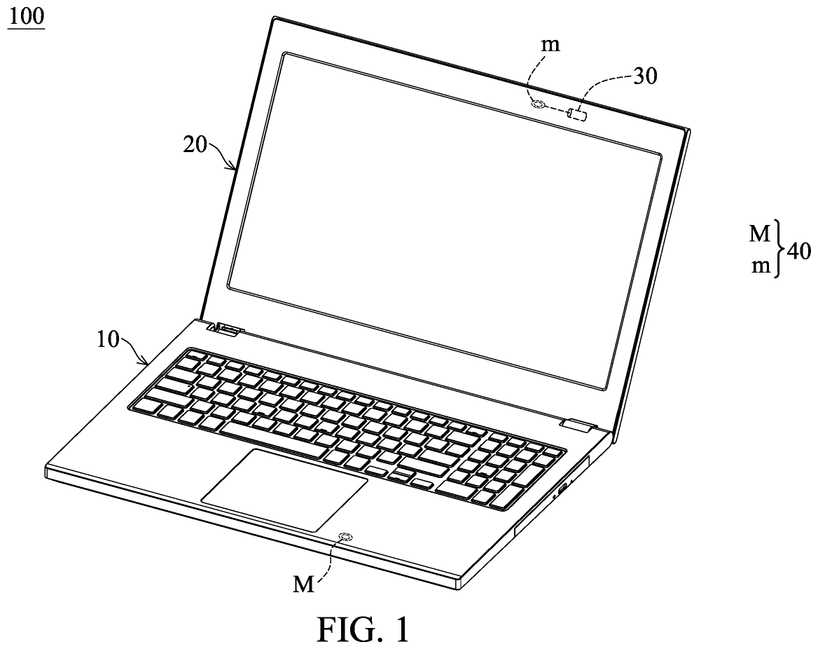

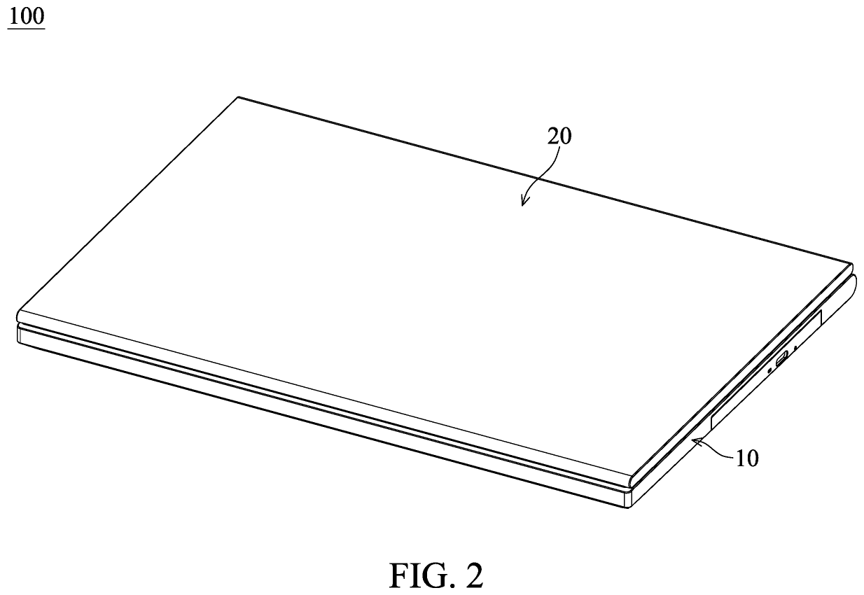

Referring to FIGS. 1, 2, and 3. FIG. 1 shows a perspective view of an electronic device 100 in the open state according to an embodiment of the present disclosure. FIG. 2 shows a perspective view of the second module 20 when rotating relative to the first module 10 in FIG. 1, whereby the electronic device 100 is switched from the open state to the closed state.

As shown in FIGS. 1 and 2, the electronic device 100 according to an embodiment of the present disclosure may be a notebook computer that mainly includes a first module 10 and a second module 20 rotatable relative to each other. The first module 10 and the second module 20 are pivotally connected to each other by the hinges, whereby the second module 20 can rotate relative to the first module 10. Thus, the electronic device 100 can be switched between the open state as shown in FIG. 1 and the closed state as shown in FIG. 2.

In this embodiment, a display screen (e.g. LCD, OLED or touch screen) is disposed on the second module 20. An input keyboard (e.g. QWERTY keyboard) and a touch panel are disposed on the surface of the first module 10, whereby the users can easily operate the electronic device 100.

In addition, as shown in FIG. 1, a main magnet element M is installed and affixed in the first module 10 of the electronic device 100. An annular auxiliary magnet element m is movably disposed in the second module 20 of the electronic device 100, and it is connected to a driving unit 30 (e.g. motor) received inside the second module 20. Here, the annular auxiliary magnet element m can rotate or slide relative to the first module 10 and the second module 20.

It should be noted that the main magnet element M and the auxiliary magnet element m form a magnet assembly 40, and they are positioned corresponding to each other. The driving unit 30 can drive the annular auxiliary magnet element m to rotate by a predetermined rotation angle relative to the main magnet element M, thereby appropriately altering the magnetic force between the main magnet element M and the auxiliary magnet element m.

Specifically, when the user finishes using the electronic device 100 and rotates the second module 20 toward the first module 10, the main magnet element M and the auxiliary magnet element M are close to each other, and they can generate a magnetic attractive holding force to stably adhere the second module 20 to the top side of the first module 10 (as shown in FIG. 2).

In this embodiment, the main magnet element M and the auxiliary magnet element m may be multipolar magnets, and each has a plurality of magnetic segments. For example, the main magnet element M and the auxiliary magnet element m may include magnetic alloy, magnetic oxide, or the combinations thereof. The magnetic alloy may comprise NdFeB, SmCo, AlNico, or the combination thereof. In addition, the magnetic oxide may comprise barium ferrite material, strontium ferrite material, lanthanum ferrite material, or the combination thereof.

It should be noted that when the auxiliary magnet element m is located at a first angular position relative to the main magnet element M, a first magnetic force is generated between the main magnet element M and the auxiliary magnet element m, whereby the second module 20 is magnetically adhered to the top side of the first module 10.

On the contrary, when the user would like to open the electronic device 100, the driving unit 30 can be used to drive the auxiliary magnet element m to rotate with respect to the main magnet element M by a predetermined angle from the first angular position to a second angular position. In this state, the main magnet element M and the auxiliary magnet element m generate a second magnetic force that is less than the first magnetic force, whereby the user can easily unfold the second module 20 relative to the first module 10, as the open state shown in FIG. 1.

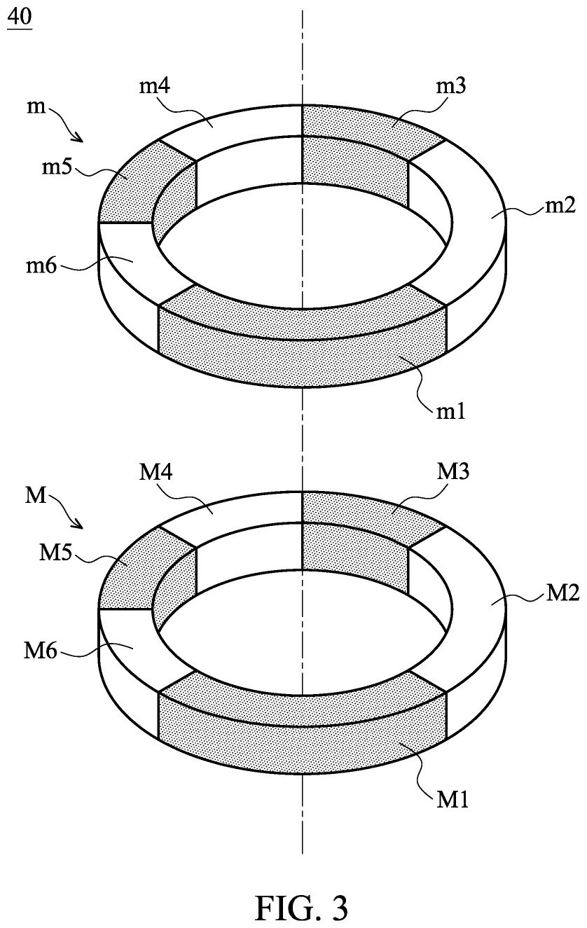

Referring to FIG. 3. FIG. 3 shows a perspective view of the main magnet element M and the auxiliary magnet element m when they are distant from each other.

As mentioned above, the main magnet element M and the auxiliary magnet element m constitute the magnet assembly 40, wherein the main magnet element M can be divided into a plurality of main magnetic segments. In this embodiment, the main magnetic segments includes a first main magnetic segment M1, a second main magnetic segment M2, a third main magnetic segment M3, a fourth main magnetic segment M4, a fifth main magnetic segment M5, and a sixth main magnetic segment M6 which are arranged in sequence.

Correspondingly, the auxiliary magnet element m can be divided into a plurality of auxiliary magnetic segments. The auxiliary magnetic segments includes a first auxiliary magnetic segment m1, a second auxiliary magnetic segment m2, a third auxiliary magnetic segment m3, a fourth auxiliary magnetic segment m4, a fifth auxiliary magnetic segment m5, and a sixth auxiliary magnetic segment m6 which are arranged in sequence.

It should be noted that the polar directions and angles of the first, second, third, fourth, fifth and sixth main magnetic segments M1-M6 are not exactly the same. Moreover, the polar directions and angles of the first, second, third, fourth, fifth and sixth auxiliary magnetic segments m1-m6 are also not exactly the same.

Specifically, the polar direction (e.g. upward) of the first, third, and fifth main magnetic segments M1, M3, and M5 are opposite to that of the second, fourth, and sixth main magnetic segments M2, M4, and M6 (e.g. downward). The polar direction (e.g. upward) of the first, third, and fifth auxiliary magnetic segments m1, m3, and m5 is opposite to that of the second, fourth, and sixth auxiliary magnetic segments m2, m4 and m6 (e.g. downward).

Additionally, the angles of the third, fourth, fifth and sixth main magnetic segments M3-M6 are less than the angles of the first and second main magnetic segments M1 and M2, and the angles of the third, fourth, fifth and sixth auxiliary magnetic segments m3-m6 are less than the angles of the first and second auxiliary magnetic segments m1 and m2.

In this embodiment, the angles of the first and second main magnetic segments M1 and M2 are substantially equal to ¼ of the angle of the main magnet element M, and the angles of the third, fourth, fifth and sixth main magnetic segments M3-M6 are substantially equal to ⅛ of the angle of the main magnet element M.

Similarly, the angles of the first and second auxiliary magnetic segments m1 and m2 are substantially equal to ¼ of the angle of the auxiliary magnet element m, and the angles of the third, fourth, fifth and sixth auxiliary magnetic segments m3-m6 are substantially equal to ⅛ of the angle of the auxiliary magnet element m.

It should be noted that the angles of the first, second, third, fourth, fifth and sixth main magnetic segments M1-M6 can be appropriately adjusted depending on the design requirements. The angles of the first, second, third, fourth, fifth and sixth auxiliary magnetic segments m1-m6 can also be adjusted appropriately according to the design requirements, and are not limited to those disclosed in the embodiments.

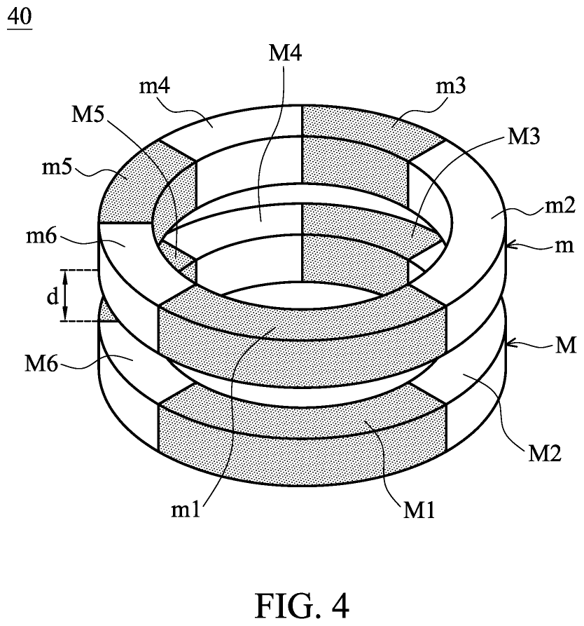

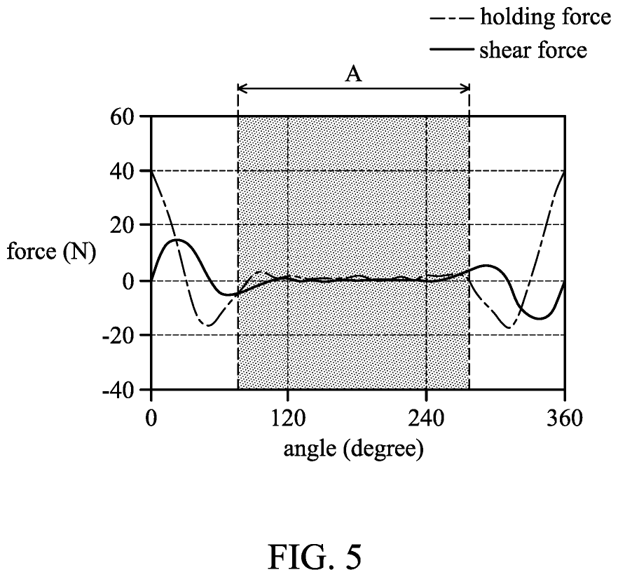

Referring to FIGS. 4 and 5. FIG. 4 shows a perspective view of the main magnet element M and the auxiliary magnet element m when close to each other. FIG. 5 is a schematic diagram showing the relationship between the angle of the auxiliary magnet element m relative to the main magnet element M and the magnetic attractive holding force/shear force between the main and auxiliary magnet elements M and m.

When the electronic device 100 is transferred from the open state of FIG. 1 to the closed state of FIG. 2, the auxiliary magnet element m on the second module 20 is close to the main magnet element M on the first module 10 (FIG. 4). In this state, the main magnet element M and the auxiliary magnet element m are spaced apart by a distance d, and the first, second, third, fourth, fifth, and the sixth main magnetic segments M1-M6 are aligned to the first, second, third, fourth, fifth and sixth auxiliary magnetic segments m1-m6 on the auxiliary magnet element m. In FIG. 4, the angular position of the magnet element m relative to the main magnet element M is 0 degrees (or 360 degrees).

As shown in FIG. 4, in this embodiment, when the auxiliary magnet element m is located relative to the main magnet element M at 0 degrees (or 360 degrees), the magnetic attractive holding force between the main and auxiliary magnet elements M and m has a maximum value (about 40 N), and the shear force is approximately 0. Hence, the second module 20 can be stably adhered to the top side of the first module 10 (as shown in FIG. 2), wherein the magnetic attractive holding force is parallel to the central axis of the main and auxiliary magnet elements M and m, and shear force is perpendicular to the central axis of the main and auxiliary magnet elements M and m.

In various embodiments of the present disclosure, the main and auxiliary magnet elements M and m have the same shape and size, wherein their circumference is substantially equal to 37.8 mm, their width and thickness are substantially equal to 3.2 mm, and they are made of the same material. Specifically, the main and auxiliary magnet elements M and m may comprise neodymium-iron-boron material (e.g. NdFeB N40) with the magnetic performance parameters of Br=13 kG and bHc=11.5 kOe, wherein the main and auxiliary magnet elements M and m have a distance of d=1 mm. It should be noted that the distance d between the main and auxiliary magnet elements M and m is configured so that the magnetic attractive holding force between the main and auxiliary magnet elements M and m is sufficient to magnetically adhere the second module to the first module. In an exemplary embodiment, the distance d may range from 1 mm to 3 mm. When the distance is 1 mm, the maximum magnetic attractive holding force is about 39 N. When the distance is 2 mm, the maximum magnetic attractive holding force is about 18 N. When the distance is 3 mm, the maximum magnetic attractive holding force is about 8 N.

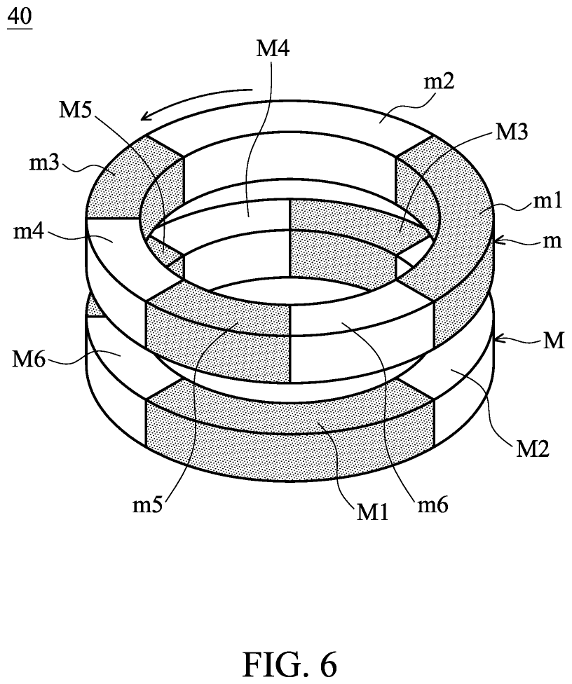

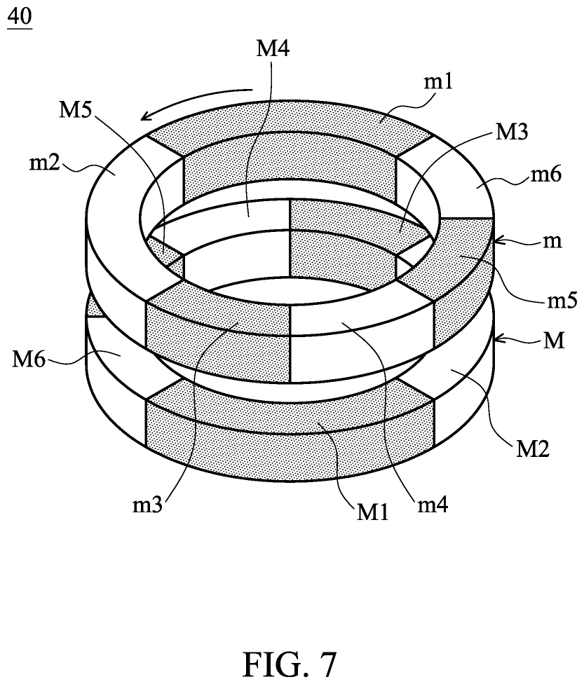

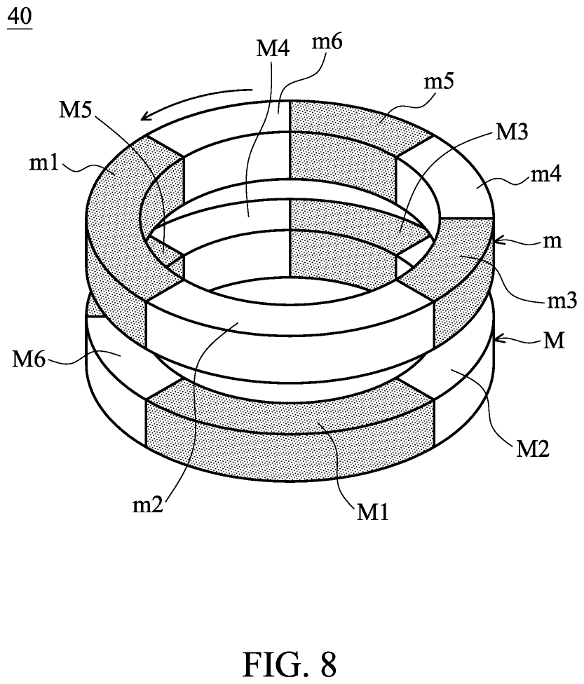

Referring to FIGS. 6, 7, and 8. FIG. 6 is a schematic diagram showing the auxiliary magnet element m when rotating 90 degrees relative to the main magnet element M from the state of FIG. 4. FIG. 7 is a schematic diagram showing the auxiliary magnet element m when rotating 180 degrees relative to the main magnet element M from the state of FIG. 4. FIG. 8 is a schematic diagram showing the auxiliary magnet element m when rotating 270 degrees relative to the main magnet element M from the state of FIG. 4.

As shown in FIG. 6, when the auxiliary magnet element m is driven by the driving unit 30 and rotates 90 degrees relative to the main magnet element M from the state of FIG. 4, only slight magnetic attractive holding force and shear force are generated between the main and auxiliary magnet elements M and m (as shown in FIG. 5). Subsequently, when the auxiliary magnet element m rotates 180 degrees relative to the main magnet element M (as shown in FIG. 7), the magnetic attractive holding force and shear force between the main and auxiliary magnet elements M and m are approximately 0 (as shown in FIG. 5).

Furthermore, when the auxiliary magnet element m rotates 270 degrees relative to the main magnet element M (as shown in FIG. 8), only slight magnetic attractive holding force and shear force are generated between the main and auxiliary magnet elements M and m (as shown in FIG. 5).

It can be clearly seen in FIG. 5 that when the auxiliary magnet element m is driven by the drive unit 30 and rotates relative to the main magnet element M within the angle range A (about 80 to 270 degrees), the user can easily unfold the second module 20 relative to the first module 10 as the open state shown in FIG. 1 because the magnetic attractive holding force and shear force generated by the main and auxiliary magnet elements M and m are very small. That is, when the auxiliary magnet element m rotates to a predetermined position that is located within the separation angle range (the gray area in FIG. 5), the main and auxiliary magnet elements M and m can be detached from each other. The separation angle range can be adjusted depending on the magnetic domain configuration. In this embodiment, the separation angle range is from 80 to 270 degrees.

In this embodiment, by changing relative angular position between the main and auxiliary magnet elements M and m disposed inside the first and second modules 10 and 20 of the electronic device 100, the magnetic attractive holding force and shear force between them can be adjusted and controlled without adding additional coils. Thus, the miniaturization of the product can be achieved.

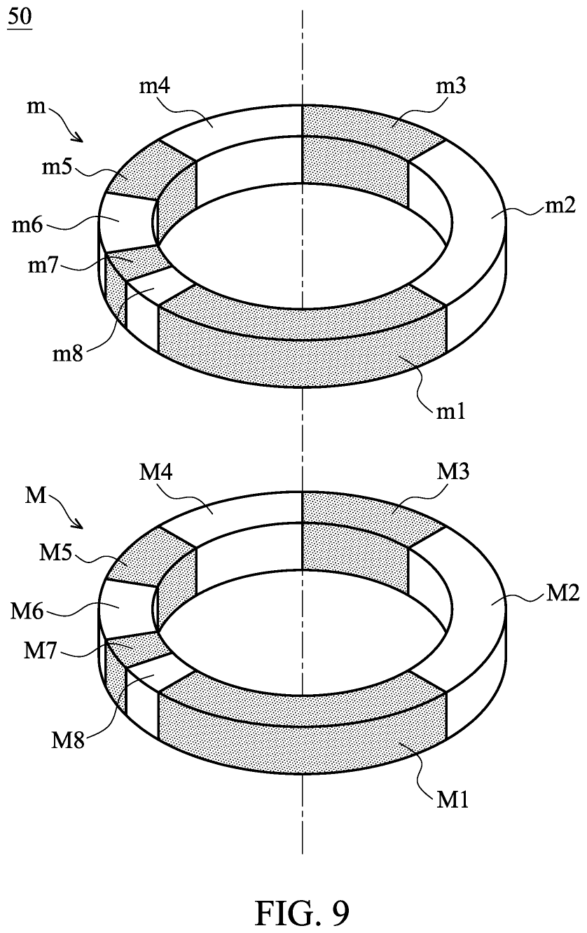

Referring to FIG. 9. FIG. 9 is a schematic diagram showing a magnet assembly 50 according to another embodiment of the present disclosure. The main difference between this embodiment and the embodiments of FIGS. 3-8 is that the main magnet element M of the magnet assembly 50 has eight main magnetic segments M1-M8, and the auxiliary magnet element m has eight auxiliary magnetic segments m1-m8.

As shown in FIG. 9, the main magnet element M in this embodiment includes a first main magnetic segment M1, a second main magnetic segment M2, a third main magnetic segment M3, and a fourth main magnetic segment M4, a fifth main magnetic segment M5, a sixth main magnetic segment M6, a seventh main magnetic segment M7, and an eighth main magnetic segment M8 arranged in sequence.

Correspondingly, the auxiliary magnet element m in this embodiment includes a first auxiliary magnetic segment m1, a second auxiliary magnetic segment m2, a third auxiliary magnetic segment m3, and a fourth auxiliary magnetic segment m4, a fifth auxiliary magnetic segment m5, a sixth auxiliary magnetic segment m6, a seventh auxiliary magnetic segment m7, and an eighth auxiliary magnetic segment m8 arranged in sequence.

Specifically, the polar direction (e.g. upward) of the first, third, fifth, and seventh main magnetic segments M1, M3, M5, and M7 is opposite to that of the second, fourth, sixth, and eighth main magnetic segments M2, M4, M6, and M8 (e.g. downward). The polar direction of the first, third, fifth, and seventh auxiliary magnetic segments m1, m3, m5, and m7 (e.g. upward) is opposite to that of the polar direction of the second, fourth, sixth, and eighth auxiliary magnet segments m2, m4, m6, and m8 (e.g. downward).

In this embodiment, the angles of the first and second main magnetic segments M1 and M2 are substantially equal to ¼ of the angle of the main magnet element M. The angles of the third and fourth main magnetic segments M3 and M4 are substantially equal to ⅛ of the angle of the main magnet element M. The angles of the fifth and sixth main magnetic segments M5 and M6 are substantially equal to 1/12 of the angle of the main magnet element M. The angles of the seventh and eighth main magnetic segments M7 and M8 are substantially equal to 1/24 of the angle of the main magnet element M.

Similarly, the angles of the first and second auxiliary magnetic segments m1 and m2 are substantially equal to ¼ of the angle of the auxiliary magnet element m. The angles of the third and fourth auxiliary magnetic segments m3 and m4 are substantially equal to ⅛ of the angle of the auxiliary magnet element m. The angles of the fifth and sixth auxiliary magnetic segments m5 and m6 are substantially equal to 1/12 of the angle of the auxiliary magnet element m. The angles of the seventh and eighth auxiliary magnetic segments m7 and m8 are substantially equal to 1/24 of the angle of the auxiliary magnet element m.

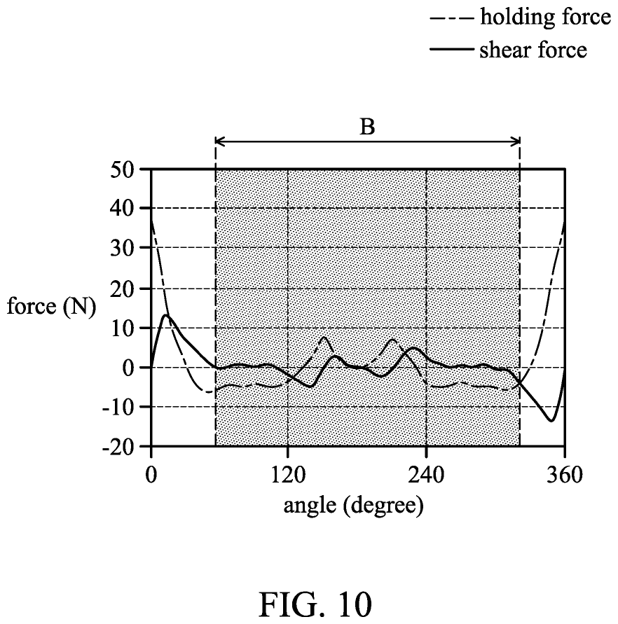

Referring to FIG. 10. FIG. 10 is a schematic diagram showing the relationship between the angle of the auxiliary magnet element m relative to the main magnet element M in FIG. 9 and the magnetic attractive holding force/shear force between the main and auxiliary magnet elements M and m.

As shown in FIG. 10, when the auxiliary magnet element m and the main magnet element M are close to each other and spaced by the distance d, and the angular position of the auxiliary magnet element m relative to the main magnet element M is at 0 degrees (or 360 degrees), the magnetic attractive holding force between the main and auxiliary magnet elements M and m has a maximum value (about 40 N), and the shear force is approximately 0.

However, when the auxiliary magnet element m is driven by the driving unit 30 and rotates relative to the main magnet element M within the angle range B (about 60 to 320 degrees), the user can easily unfold the second module 20 relative to the first module 10 as the open state shown in FIG. 1 because the magnetic attractive holding force and shear force generated by the main and auxiliary magnet elements M and m are very small. That is, when the auxiliary magnet element m rotates to a predetermined position that is located within the separation angle range (the gray area in FIG. 10), the main and auxiliary magnet elements M and m can be detached from each other. The separation angle range can be adjusted depending on the magnetic domain configuration. In this embodiment, the separation angle range is from 60 to 320 degrees.

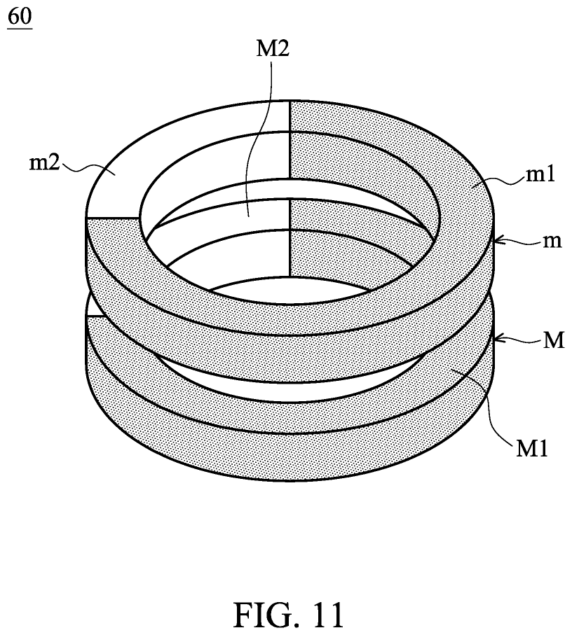

Referring to FIG. 11. FIG. 11 is a schematic diagram showing a magnet assembly 60 according to another embodiment of the present disclosure. The main difference between this embodiment and the embodiments of FIGS. 3-10 is that the main magnet element M of the magnet assembly 60 in this embodiment only has two main magnetic segments M1 and M2, and the auxiliary magnet element m only has two auxiliary magnetic segments m1 and m2. The first and second main magnetic segments M1 and M2 have different angles, and their polar directions are opposite to each other. In addition, the first and second auxiliary magnetic segments m1 and m2 have different angles, and their polar directions are also opposite to each other.

In this embodiment, the angle of the first main magnetic segment M1 exceeds ½ of the angle of the main magnet element M, and the angle of the first auxiliary magnetic segment m1 exceeds ½ of the angle of the auxiliary magnet element m.

Specifically, the present disclosure can alter the magnetic attractive holding force and shear force between the main and auxiliary magnet elements M and m by changing the magnetic domain configuration and relative rotation therebetween, wherein the main and auxiliary magnet elements M and m may comprise neodymium-iron-boron material that is capable of demagnetization, thus achieving magnetic force control and minimization of assembly tolerance. In addition, the main and auxiliary magnet elements M and m can be used in magnetic fixing devices, precision positioning systems, and other engineering and scientific applications which need to control magnetic force.

For example, the main magnet element M of the magnet assemblies 40, 50, 60 may be disposed on a magnetic suction base (magnetic base), and the auxiliary magnet element m may be disposed on another part. The part can be rotated manually without the driving unit 30 to change the magnetic domain configuration between the part and the magnetic base during usage, and the part and the magnetic base can rotate and separate from each other accordingly. In an exemplary embodiment, the part may be a Bluetooth headset or a carrier used to hold the Bluetooth headset, but is not limited to those disclosed in the embodiment.

It should be noted that the angle of each of the main magnetic segments M1-M8 and the auxiliary magnetic segments m1-m8 in the magnet assemblies 40, 50, 60 ranges from 15 to 90 degrees. Moreover, the main magnetic segments M1-M8 and the auxiliary magnetic segments m1-m8 are arranged in a manner that the angles thereof gradually increase, but are not limited to those disclosed in the embodiment.

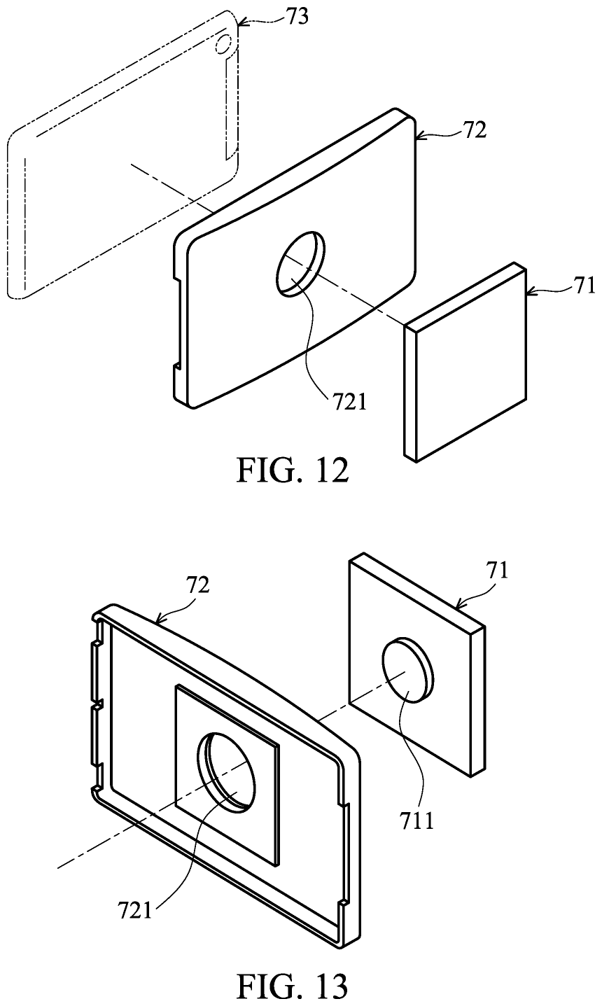

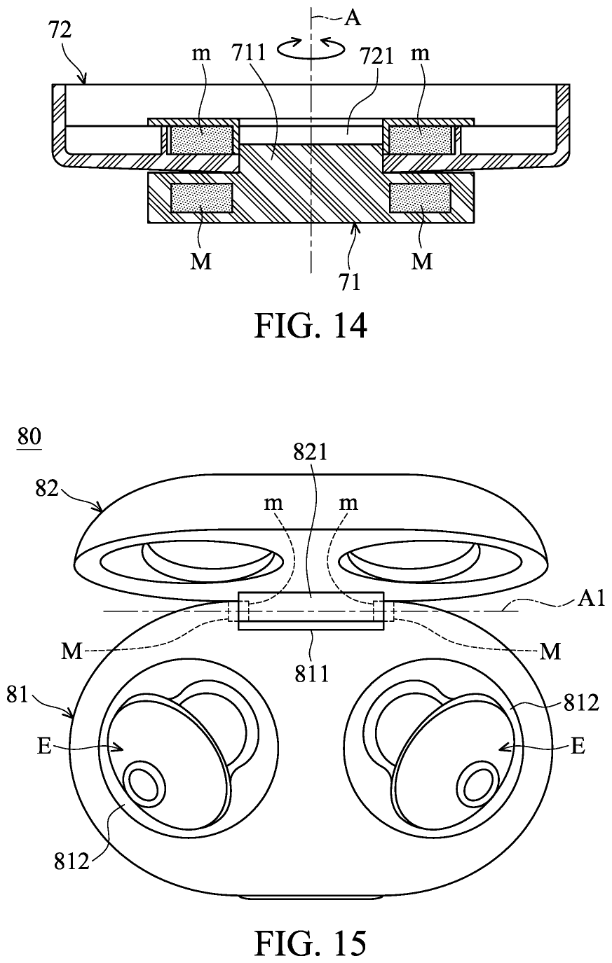

Referring to FIGS. 12, 13, and 14. FIG. 12 is an exploded view of the first member 71, the second member 72, and the mobile phone 73 before assembly, in accordance with another embodiment of the present disclosure. FIG. 13 is an exploded view of the first member 71 and the second member 72 in FIG. 12 from another viewing angle. FIG. 14 is a cross-segmental view of the first member 71 and the second member 72 in FIG. 13 after assembly.

As shown in FIGS. 12, 13, and 14, the main magnet element M in each of the aforementioned embodiments may be disposed in the first member 71 (e.g. support base), and the auxiliary magnet element m may be disposed in the second member 72 (e.g. the protective case of the mobile phone 73), wherein the main and auxiliary magnet elements M, m and the first and second members 71, 72 form a magnetic connection mechanism 70.

Specifically, a protrusion 711 (FIG. 13) is formed at the center of the first member 71, and a hole 721 is formed at the center of the second member 72. When the user assembles the second member 72 to the first member 71, the protrusion 711 at the center of the first member 71 can be inserted into the hole 721 at the center of the second member 72. In this state, the main magnet element M inside the first member 71 and the auxiliary magnet element m inside the second member 72 are close to each other. When the auxiliary magnet element m is located at a first angular position relative to the main magnet element M, a first magnetic force is generated between the main magnet element M and the auxiliary magnet element m, whereby the second member 72 can be stably adhered to the first member 71 (as shown in FIG. 14).

However, to detach the second member 72 from the first member 71, the second member 72 can be manually rotated relative to the first member 71 around the rotation axis A. Hence, the auxiliary magnet element m rotates relative to the main magnet element M from the first angular position to a second angular position, whereby the user can easily remove the second member 72 from the first member 71.

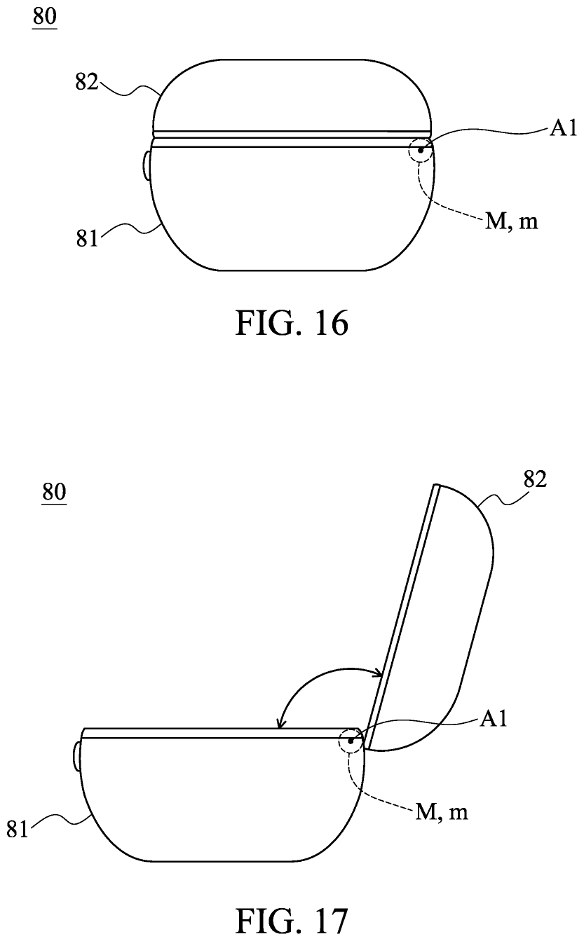

Referring to FIGS. 15, 16, and 17. FIG. 15 is a schematic diagram showing a magnetic connection mechanism 80 (headphone box) in accordance with another embodiment of the present disclosure. FIG. 16 is a side view of the second member 82 in FIG. 15 when closed relative to the first member 81. FIG. 17 is a side view of the second member 82 in FIG. 15 when opened relative to the first member 81.

As shown in FIGS. 15, 16, and 17, the main magnet element M in the aforementioned embodiments may also be disposed in the first member 81 (lower housing) of a magnetic connection mechanism 80 (e.g. earphone box), and the auxiliary magnet element m may be disposed in the second member 82 (upper housing) of the magnetic connection mechanism 80, wherein a recess 811 is formed on a side of the first member 81, and cavities 812 are formed on the first member 81 for receiving the Bluetooth headset E. Moreover, a hinge portion 821 is formed on a side of the second member 82 and movably received in the recess 811.

It can be seen in FIG. 16 that when the auxiliary magnet element m is located at a first angular position relative to the main magnet element M, a first magnetic force is generated between the main magnet element M and the auxiliary magnet element m, whereby the second member 82 (upper housing) is stably adhered to the top side of the first member 81 (lower housing).

However, when the user manually rotates the second member 82 relative to the first member 81 around a horizontal axis A1, the second member 82 is unfolded relative to the first member 81 (as shown in FIG. 17), and the auxiliary magnet element m rotates relative to the main magnet element M from the first angular position to a second angular position. In this state, since only a small magnetic attraction force (second magnetic force) is generated between the second member 82 (upper case) and the first member 81 (lower case), the second member 82 can be easily folded back towards the first member 81 by the user.

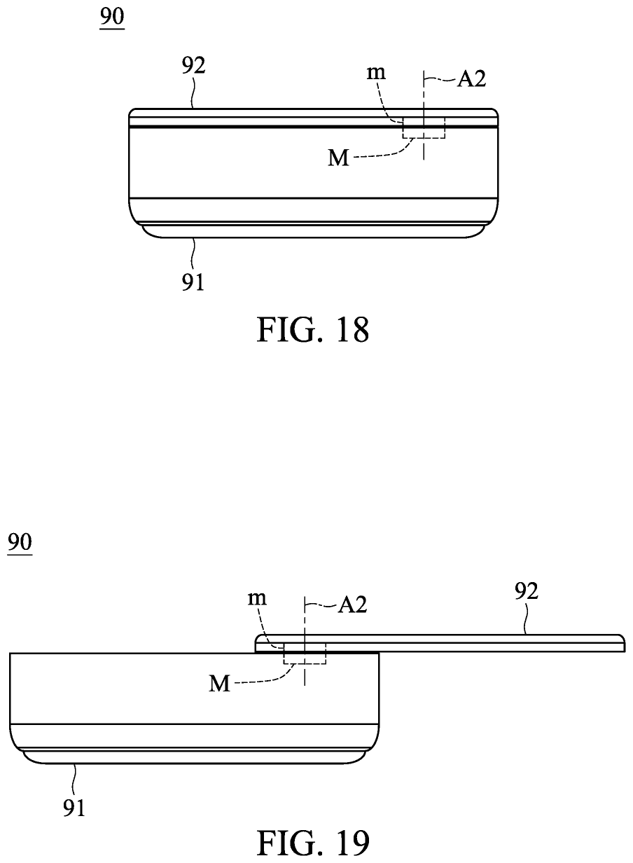

Referring to FIGS. 18 and 19. FIG. 18 is a side view showing the second member 92 of the magnetic connection mechanism 90 (e.g. headphone box) when closed relative to the first member 91, in accordance with another embodiment of the present disclosure. FIG. 19 is a side view showing the second member 92 in FIG. 18 when opened relative to the first member 91.

As shown in FIGS. 18 and 19, the main difference between this embodiment and the embodiment in FIGS. 15, 16 and 17 is that the second member 82 (upper housing) in this embodiment can rotate relative to the first member 81 (lower housing) around a vertical axis A2.

It can be seen in FIG. 18 that when the auxiliary magnet element m is located at a first angular position relative to the main magnet element M, a first magnetic force is generated between the main magnet element M and the auxiliary magnet element m, whereby the second member 92 is stably adhered to the top side of the first member 91.

However, when the user manually rotates the second member 92 relative to the first member 91 around the vertical axis A2, the second member 92 is opened relative to the first member 91 (as shown in FIG. 19), and the auxiliary magnet element m rotates relative to the main magnet element M from the first angular position to a second angular position. In this state, since only a small magnetic attraction force (second magnetic force) is generated between the second member 92 and the first member 91, the second member 92 can be easily rotated back to the first member 91.

As mentioned above, the present disclosure provides a main magnet element M and an annular auxiliary magnet element m that have a plurality of magnetic segments with opposite polar directions and different angles. By changing relative angular position between the main and auxiliary magnet elements M and m, the magnetic attractive holding force and shear force between them can be adjusted and controlled without adding additional coils, and they can be widely applied in various consumer and industrial products. Moreover, the present disclosure can achieve miniaturization of the product.

It will be clear that various modifications and variations can be made to the disclosed methods and materials. It is intended that the specification and examples be considered as exemplary only, with the true scope of the disclosure being indicated by the following claims and their equivalents.

1. A magnetic assembly, including:
an annular main magnetic element, having a plurality of main magnetic segments, wherein the polar directions of the main magnetic segments are not exactly the same, and the angles of the main magnetic segments are not exactly the same; and
an annular auxillary magnetic element, movably disposed on a side of the main magnetic element and having a plurality of axillary magnetic segments corresponding to the main magnetic segments, wherein the polar directions of the axillary magnetic segments are not exactly the same, and the angles of the axillary magnetic segments are not exactly the same.

2. The magnetic assembly as claimed in claim 1, wherein the main magnetic segments includes a first main magnetic segment and a second main magnetic segment adjacent to each other, and the axillary magnetic segments includes a first axillary magnetic segment and a second axillary magnetic segment adjacent to each other.

3. The magnetic assembly as claimed in claim 2, wherein the angle of the first main magnetic segment exceeds ½ of the angle of the main magnetic element, and the angle of the first axillary magnetic segment exceeds ½ of the angle of the axillary magnetic element.

4. The magnetic assembly as claimed in claim 2, wherein the main magnetic segments further includes a third main magnetic segment, a fourth main magnetic segment, a fifth main magnetic segment, and a sixth main magnetic segment, and the axillary magnetic segments further includes a third axillary magnetic segment, a fourth axillary magnetic segment, a fifth axillary magnetic segment, and a sixth axillary magnetic segment, wherein the angles of the third, fourth, fifth, and sixth main magnetic segments are less than the angles of the first and second main magnetic segments, and the angles of the third, fourth, fifth, and sixth axillary magnetic segments are less than the angles of the first and second axillary magnetic segments.

5. The magnetic assembly as claimed in claim 4, wherein the angles of the first and second main magnetic segments are respectively equal to ¼ of the angle of the main magnetic element, and the angles of the first and second axillary magnetic segments are respectively equal to ¼ of the angle of the axillary magnetic element.

6. The magnetic assembly as claimed in claim 5, wherein the angles of the third, fourth, fifth, and sixth main magnetic segments are respectively equal to ⅛ of the angle of the main magnetic element, and the angles of the third, fourth, fifth, and sixth axillary magnetic segments are respectively equal to ⅛ of the angle of the axillary magnetic element.

7. The magnetic assembly as claimed in claim 2, wherein the main magnetic segments further includes a third main magnetic segment, a fourth main magnetic segment, a fifth main magnetic segment, a sixth main magnetic segment, a seventh main magnetic segment, and a eighth main magnetic segment, and the axillary magnetic segments further includes a third axillary magnetic segment, a fourth axillary magnetic segment, a fifth axillary magnetic segment, a sixth axillary magnetic segment, a seventh main magnetic segment, and a eighth main magnetic segment, wherein the angles of the third, fourth, fifth, sixth, seventh, and eighth main magnetic segments are less than the angles of the first and second main magnetic segments, and the angles of the third, fourth, fifth, sixth, seventh, and eighth axillary magnetic segments are less than the angles of the first and second axillary magnetic segments.

8. The magnetic assembly as claimed in claim 7, wherein the angles of the first and second main magnetic segments are respectively equal to ¼ of the angle of the main magnetic element, and the angles of the first and second axillary magnetic segments are respectively equal to ¼ of the angle of the axillary magnetic element.

9. The magnetic assembly as claimed in claim 8, wherein the angles of the third and fourth main magnetic segments are respectively equal to ⅛ of the angle of the main magnetic element, and the angles of the third and fourth axillary magnetic segments are respectively equal to ⅛ of the angle of the axillary magnetic element.

10. The magnetic assembly as claimed in claim 9, wherein the angles of the fifth and sixth main magnetic segments are respectively equal to 1/12 of the angle of the main magnetic element, and the angles of the fifth and sixth axillary magnetic segments are respectively equal to 1/12 of the angle of the axillary magnetic element.

11. The magnetic assembly as claimed in claim 10, wherein the angles of the seventh and eighth main magnetic segments are respectively equal to 1/24 of the angle of the main magnetic element, and the angles of the seventh and eighth axillary magnetic segments are respectively equal to 1/24 of the angle of the axillary magnetic element.

12. The magnetic assembly as claimed in claim 7, wherein the first, second, third, fourth, fifth, sixth, seventh, and eighth main magnetic segments are sequentially arranged along the main magnetic element, and the first, second, third, fourth, fifth, sixth, seventh, and eighth axillary magnetic segments are sequentially arranged along the axillary magnetic element.

13. The magnetic assembly as claimed in claim 1, wherein the main magnetic element and the axillary magnetic element comprise magnetic alloy, magnetic oxide, or the combination thereof.

14. The magnetic assembly as claimed in claim 1, wherein the main magnetic element and the axillary magnetic element comprise NdFeB, SmCo, AlNiCo, or the combination thereof.

15. The magnetic assembly as claimed in claim 1, wherein the main magnetic element and the axillary magnetic element comprise barium ferrite material, strontium ferrite material, lanthanum ferrite material, or the combination thereof.

16. The magnetic assembly as claimed in claim 1, wherein the main magnetic segments and the axillary magnetic segments are both arranged in a manner that the angles thereof gradually increase.

17. An electronic device, including:
a magnetic assembly as claimed in claim 1;
a first module, wherein the main magnetic element is disposed on the first module; and
a second module, wherein the axillary magnetic element is movably disposed on the second module, and when the axillary magnetic element is located at a first angular position relative to the main magnetic element, the main magnetic element and the axillary magnetic element generate a first magnetic force, whereby the second module is magnetically adhered to the first module;
wherein when the axillary magnetic element rotates from the first angular position relative to the main magnetic element to a second angular position, the main magnetic element and the axillary magnetic element generate a second magnetic force that is less than the first magnetic force.

18. The electronic device as claimed in claim 17, further including a driving unit disposed on the second module and connected to the axillary magnetic element.

19. A magnetic connection mechanism, including:
a magnetic assembly as claimed in claim 1;
a first member, wherein the main magnetic element is disposed on the first member; and
a second member, wherein the axillary magnetic element is disposed on the second member, and when the axillary magnetic element is located at a first angular position relative to the main magnetic element, the main magnetic element and the axillary magnetic element generate a first magnetic force, whereby the second member is magnetically adhered to the first member;
wherein when the axillary magnetic element rotates from the first angular position relative to the main magnetic element to a second angular position, the main magnetic element and the axillary magnetic element generate a second magnetic force that is less than the first magnetic force.

20. The electronic device as claimed in claim 19, wherein the first member forms a protrusion, and the second member forms a hole, wherein the protrusion extends into the hole.
